(19) United States
(12) Patent Application Publication
(10) Pub. No.: US 2005/0144987 A1
(43) Pub. Date: Jul. 7, 2005

(54) Method for making a preform

(75) Inventors: Emmanuel Petitfrere, Villeneuve d'Ascq (FR); Cedric Gonnet, Lille (FR)

Correspondence Address: SUGHRUE MION, PLLC, 2100 PENNSYLVANIA AVENUE, N.W., SUITE 800, WASHINGTON, DC, 20037, US

(73) Assignee: DRAKA COMTEQ B.V.

(21) Appl. No.: 10/978,335

(22) Filed: Nov. 2, 2004

(30) Foreign Application Priority Data
Nov. 3, 2003 (FR) 0312961

(51) Int. Cl. C03B 37/018

(52) U.S. Cl. 65/413; 65/435; 428/542.8

(57) ABSTRACT

A method for producing an optical fiber preform (100) consists in producing a primary preform (110); drawing out an end portion (115) of the primary preform (110) to produce a tail portion (115); thickening (120) the primary preform; and forming a cone (130) on the drawn out tail portion at the end of the primary preform. As a result of drawing out an end portion of the primary preform, the amount of primary preform required for cone formation is reduced while simultaneously optimizing cone length and angle appropriate to good initiation of fiber drawing.

The present invention relates to a method for producing an optical fiber preform.

An optical fiber is produced by drawing a preform in a drawing tower. Preform geometry should perfectly reflect the fiber core and cladding refractive index ratios and diameters. Preform manufacture is consequently an essential step in optical fiber production. Conventionally, a 10 cm diameter preform one metre long can for example yield 500 km of 125 micron diameter fiber.

A preform generally comprises a primary preform constituted by a very high quality glass rod or bar about 30 mm in diameter which forms part of the fiber cladding and the fiber core. This primary preform is subsequently thickened to increase its diameter and form a preform suitable for use on a drawing tower.

The fiber drawing operation consists in placing the preform vertically in the tower and drawing a fiber filament from one end of the preform. While doing this, a high temperature is applied locally to an end of the preform until the silica softens, and fiber drawing speed and temperature are then permanently controlled during drawing as these determine the fiber diameter.

Fiber drawing is initiated at one end of the heated preform. This end of the preform is preferably shaped into a cone in order to facilitate initiation of fiber drawing. The production of such a cone at an end of a preform is in particular disclosed in European patent application 1,035,080. Additionally, United States Patent Application US 2001 0023598 discloses a method for producing a cone to obtain an improved shape for initiating drawing.

The preform cone should be sufficiently long to ensure good initiation of fiber drawing and sufficiently small to ensure minimal material loss. Indeed, the end of the preform used to start fiber drawing is in general damaged by the fiber drawing tools responsible for drawing the fiber. The cone portion of the preform is consequently generally lost for the optical fiber.

Depending on the types of fiber to be produced and the production method used, preforms can have relatively large diameters. Now, preform diameter impacts on the shape of the cone.

Indeed, the following relation L=φ/2*tan α, relating length L and cone angle α to preform diameter φ can be established.

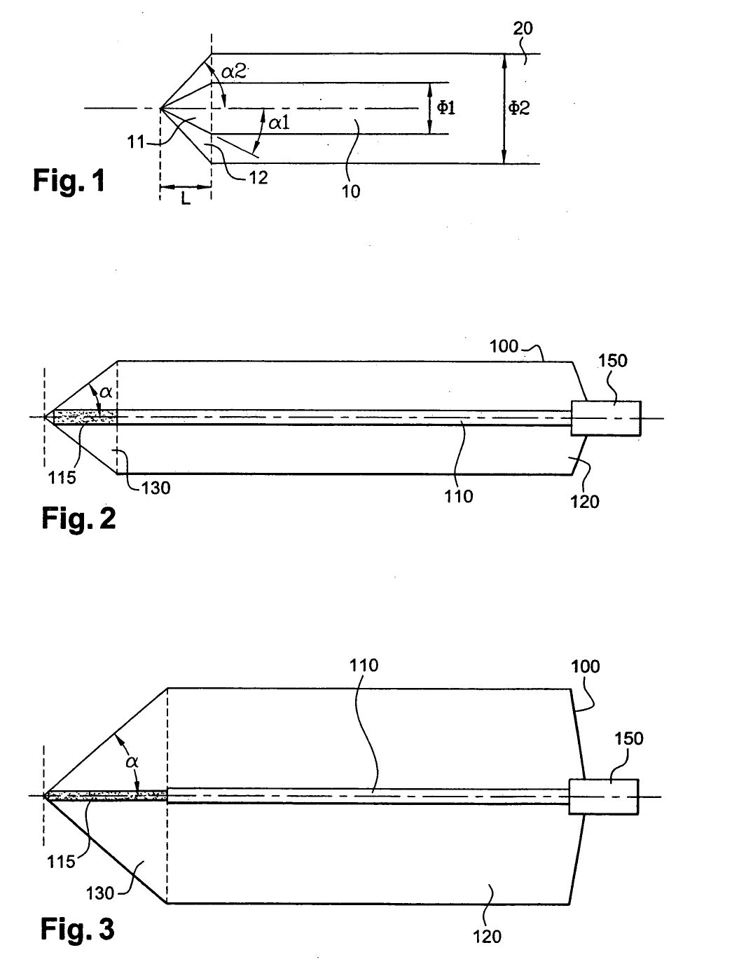

Thus, as illustrated diagrammatically in FIG. 1, a preform 10 of diameter φ₁ will have a cone 11 making angle α₁ with the preform axis; and a preform 20 of diameter φ₂, greater than φ₁, will have a cone 12 making an angle α₂ greater than α₁. This increase in cone angle α when preform diameter increases is imposed by the constraint of only employing a minimal portion of the preform of length L to produce a cone, this portion being wasted for the optical fiber.

However, a higher cone angle α makes initiation of fiber drawing more difficult as regulation of fiber drawing tension and speed are highly sensitive at this angle. Further, a constant cone angle α requires increasing cone length for higher diameter preforms, with the resulting waste of material involved.

The present invention thus sets out to provide a method for producing a preform making it possible to create a cone at one end thereof by optimizing the amount of preform employed for this purpose, while still ensuring optimum cone geometry for fiber drawing initiation.

More specifically, the invention provides a method for producing a preform comprising:
producing a primary preform;
drawing out an end portion of said primary preform to form a tail portion;
thickening the primary preform;
forming a cone on a tail portion of said preform corresponding to said drawn out tail portion of the primary preform.

Preferably, the drawing out of the primary preform is performed on a length thereof less than or equal to 5% of the initial length of said primary preform.

Preferably, the drawing out of the end portion of the primary preform is performed so as to increase the length of said tail portion by at least 100%.

Preferably, the drawing out of the tail portion of the primary preform is performed by heating said portion and exercising a tractional force thereon.

Further the invention concerns an optical fiber preform comprising:
a primary preform comprising a drawn out tail portion;
a thickening surrounding said primary preform;
a cone arranged on an end portion of said preform corresponding to said drawn-out tail portion of the primary preform.

Preferably, the length of said drawn out tail portion of the primary preform is comprised between 4 and 15 cm for a preform substantially 1 m long.

In a preferred feature, the length of the drawn out tail portion of the primary preform is proportional to the diameter of the preform.

Further characteristics and advantages of the invention will become more clear from the description which follows of some embodiments provided by way of example and with reference to the attached drawings.

FIG. 1, already described, shows two preforms of different diameters superimposed on each other.

FIG. 2 shows a preform according to a first embodiment of the invention.

FIG. 3 shows a preform according to a second embodiment of the invention.

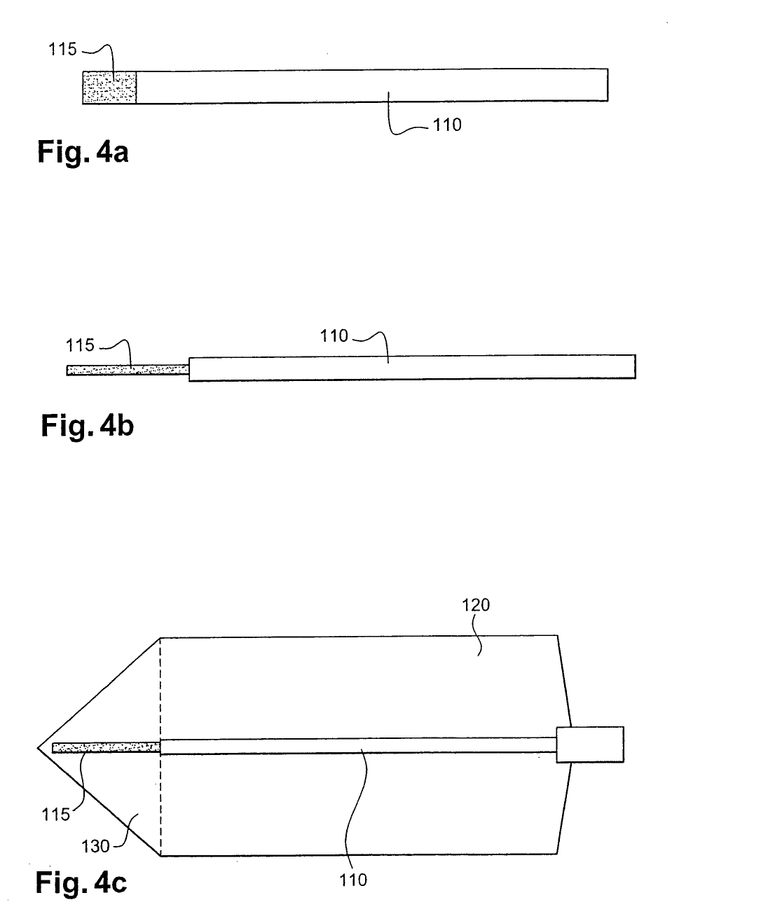

FIGS. 4a to 4c show the steps in a production process of a preform according to the invention.

The invention provides a fiber optical preform comprising a primary preform and a subsequent thickening surrounding the primary preform. The primary preform comprises a drawn out tail portion. A cone is arranged on an end of the preform corresponding to the drawn out end or tail of the primary preform. The length of the cone can consequently be adapted as a function of preform diameter using a larger or smaller primary preform drawn out tail portion.

The invention also provides a method of producing such a preform, consisting in producing a primary preform; drawing out an end portion of this primary preform; thickening of the primary preform, and forming a cone on an end of the preform corresponding to said drawn out tail portion of the primary preform.

As a result of the drawing out an end of the primary preform, overall loss of primary preform for cone formation can be limited while optimizing cone length and angle to achieve good initiation of fiber drawing.

The preform of the invention will now be described in more detail with reference to FIGS. 2 and 3 which illustrate two embodiments of the invention for two preforms of different diameters.

A preform 100 is constituted of a primary preform 110 and a subsequent thickening 120 surrounding the primary preform. As discussed above, the primary preform 110 is a bar or rod of around 30 mm diameter which forms a part of the cladding and the core of the fiber. To produce the primary preform 110, the bar is generally mounted horizontally and retained at its two ends by glass slugs 150 in a specialized lathe. The bar is driven in rotation and locally heated for depositing components determining the composition of the primary preform. This composition determines the optical characteristics of the future fiber. Various known production techniques can be employed for making this primary preform from a silica bar, such as modified chemical vapor deposition (MCVD) or plasma-assisted chemical vapor deposition (PCVD or PMCVD) or any other inside vapor deposition (IVD) technique for the bar.

Subsequent thickening 120 then constitutes a supplement of material surrounding primary preform 110 in order, firstly, to render the preform utilizable on a fiber drawing tower and secondly to obtain a preform 100 with a diameter predefined as a function of the fiber to be drawn. Subsequent thickening 120 can be obtained starting from a silica powder that is sprayed in molten form onto primary preform 110 using a known technique.

A cone 130 is then formed on an end of the preform. Such a cone can be formed directly during thickening, by reducing the amount of silica powder that is sprayed, while simultaneously pulling on or drawing out the preform. The cone can also be formed after the subsequent thickening step by heating and drawing out one end of preform 100. Typically, in order to detach the preform from the specialized lathe, one end is detached from one of the retaining slugs, the other end remaining attached to a retaining slug 150, to form a handle for handling it. During this operation, the end of the preform from which the retaining slug 150 is to be detached can be heated while at the same time pulling on the retaining slug before detaching it, and thereby forming the cone.

According to the invention, the primary preform 110 is pulled out at one end 115 before forming the cone.

Elongation at a tail portion 115 of the primary preform depends on the desired final shape of preform 100. In effect, cone 130 is designed to then be provided on this drawn out tail portion 115 of the primary preform 110. Thus, if we apply the relation L=φ/2*tan α given above, the greater the diameter of the final preform (FIG. 3), the greater the extent primary preform 110 should be drawn out at its end 115 to enable a longer cone to be formed thereby maintaining a substantially constant cone angle α. Preferably, it is desirable to maintain a cone angle α comprised between 20 and 45°.

Nevertheless, even in the case of a smaller diameter preform 100 (FIG. 2), one end 115 of primary preform 110 can also be drawn out in order to reduce the proportion of primary preform wasted by cone 130. Indeed, as discussed above, primary preform 110 requires high precision manufacture. It is consequently advantageous to be able to employ the maximum of the length of this primary preform 110 to provide a fiber, and to reduce waste at the cone provided for initiating fiber drawing to a minimum.

For example, for a primary preform 110 substantially one metre long, an end portion 115 of 2 cm is drawn out over 3 cm to form a 5 cm drawn tail end, which is a suitable length for a cone 130 on a final 6 cm diameter preform 100.

Similarly, in the case of, for example, a 12 cm diameter preform, primary preform 110 can have a 3 cm end 115 drawn out by 7 cm in order to form a 10 cm long cone 130 but having a cone angle substantially the same as that of a 6 cm diameter preform. The time taken to thin down the fiber, when starting up the drawing operation, can thus be considerably reduced.

FIGS. 4a to 4c illustrate diagrammatically the steps in the production of a preform according to the invention.

A primary preform 110 is produced, using any known technique (FIG. 4a). One end 115 of this primary preform 110 is then drawn out (FIG. 4b). The drawing out of the primary preform can be performed over a length 115 thereof less than or equal to 5% of the initial length of primary preform 110; the drawing out of tail portion 115 can be performed so as to increase the length of said portion 115 by at least 100%. The initial and drawn out lengths of tail portion 115 of primary preform 110 depend on the shape desired for the cone 130 of final preform 100.

For example, on a primary preform about 1 m long, a 2 cm long portion 115 is drawn out by 3 cm to a length of 5 cm. The drawn out portion 115 need not necessarily have the optical qualities required for the final fiber since this portion 115 is designed to carry the cone which will be rejected after fiber drawing. The drawing conditions applying to portion 115 are consequently purely mechanical and do not require to comply with drawing constraints as regards optical homogenization of the primary preform.

The tail portion 115 of primary preform 110 can consequently simply be obtained by heating said portion and pulling it. For example, a plasma torch or blowpipe can be employed for heating tail portion 115 of primary preform 110 and a suitably adapted specialized glass-making lathe can be used to pull on a retaining slug in order to elongate tail portion 115.

Primary preform 110, with tail portion 115 is then thickened and a cone is formed (FIG. 4c) on the drawn-out tail portion 100 of the primary preform. Cone 130 is formed using any known technique, for example the one described above consisting in heating and pulling thickened preform 100 by pulling one of the retaining slugs 150.

Obviously, this invention is not limited to the examples and embodiments described and illustrated, but may be subject to numerous variations available to those skilled in the art. In particular, the primary preform production and thickening techniques can be adapted depending on the type of fiber to be made, and the cone formed on the drawn out tail portion of the preform can be obtained using any technique

1. A method for producing a preform (100) comprising the steps of:
producing a primary preform (110);
drawing out an end portion (115) of said primary preform (110) to form a tail portion;
thickening (120) the primary preform;
forming a cone (130) on a tail portion of said perform corresponding to said drawn out tail portion (115) of the primary perform.

2. The method according to claim 1, wherein the drawn out of the primary preform (110) is performed on an end portion (115) thereof less than or equal to 5% of the initial length of said primary perform.

3. The method according to claim 1, wherein the drawing out of the end portion (115) of the primary preform (110) is performed so as to increase the length of said tail portion by at least 100%.

4. A method according to claim 1, wherein the drawing out of the end portion (115) of the primary preform (110) is performed by heating said portion and exercising a tractional force thereon.

5. An optical fiber preform comprising:
a primary preform (110) comprising a drawn out tail portion (115);
a thickening (120) surrounding said primary preform (110);
a cone (130) arranged on an end portion of said preform corresponding to said drawn-out tail portion (115) of the primary preform.

6. The preform according to claim 5, wherein the length of said drawn out tail portion (115) of the primary preform (110) is comprised between 4 and 15 cm for a preform (100) substantially 1 m long.

7. The preform according to claim 5, wherein the length of the drawn out tail portion (115) of the primary preform (110) is proportional to the diameter of the preform.

8. The method according to claim 2, wherein the drawing out of the end portion (115) of the primary preform (110) is performed so as to increase the length of said tail portion by at least 100%.

9. A method according to claim 2, wherein the drawing out of the end portion (115) of the primary preform (110) is performed by heating said portion and exercising a tractional force thereon.

10. A method according to claim 3, wherein the drawing out of the end portion (115) of the primary preform (110) is performed by heating said portion and exercising a tractional force thereon.

11. The preform according to claim 6, wherein the length of the drawn out tail portion (115) of the primary preform (110) is proportional to the diameter of the preform.
